(19) United States
(12) Patent Application Publication
(10) Pub. No.: US 2009/0205331 A1
(43) Pub. Date: Aug. 20, 2009

(54) Piston based double compounding engine

(76) Inventor: J. Kendall Marsh, Wolcottville, IN (US)

Correspondence Address: Ken Marsh, 6145 S 400 E, Wolcottville, IN, 46795, US

(21) Appl. No.: 12/070,402

(22) Filed: Feb. 19, 2008

(51) Int. Cl. F02B 29/04; F02B 75/28; F02B 33/40

(52) U.S. Cl. 60/599; 123/51 R

(57) ABSTRACT

A unique piston based, two cycle, internal combustion engine using turbocompounding to recover exhaust heat and a hot air cycle to recover jacket heat. Three engines operate together and share components to make a mechanically simple device. Air and exhaust are the only working fluids. All working cycles are open. There are no external heat exchangers or pumps. Power can be taken from the engine as mechanical shaft power or electrical with the preferred method being electrical.

### CROSS-REFERENCE TO RELATED APPLICATIONS

Not Applicable

### FEDERALLY SPONSORED RESEARCH

Not Applicable

### REFERENCE TO SEQUENCE LISTING

Not Applicable

### BACKGROUND OF THE INVENTION

In the never ending quest for a clean and efficient prime mover, one system, the Otto Cycle, has emerged absolute king. Yet it seems like the Otto cycle with an overall conversion efficiency less than 50% of Carnot efficiency would be an ideal candidate for replacement. With thousands of patents issued for alternative engines over the last 100 years, one would think that at least one of them would be valuable enough to have some of the market. However, at the present, there is no practical challenge to the Otto Cycle.

In applying the first law of thermodynamics, the conservation of energy, to the Otto Cycle we find that approximately one third of input energy is converted to shaft power, one third of the input energy is expelled in the exhaust stream and one third of the input energy goes to heat various engine components. Obviously, since the reason for this engine is to produce shaft power, two thirds of the energy used is sinked to the environment without producing the desired product. The problem is further compounded since the Otto Cycle has one preferred point of efficient operation. At all other outputs the engine exhibits reduced efficiency. In automotive applications 90% of the time the engine is operating significantly off its point of maximum efficiency.

In reviewing the many prime mover options one thing becomes clear. No single cycle is capable of converting more than approximately one third of the input energy into mechanical power. However, historically there are examples of combined cycles that produced more than the approximate one third efficiency. One of these is the Cyclone aircraft engine that appeared shortly after the second world war. This engine which was proven in thousands of combat missions was fitted with turbines to recover shaft power from exhaust heat. The combination engine exhibited a most significant increase in power and efficiency. Approximately 30% of engine shaft output power was power recovered directly from exhaust heat. Airplanes with turbo compounding engines were popular for making the transatlantic hop since with the higher efficiency they could do so without refueling. However reliability was an issue. The planes commonly would arrive at destination with one or two engines feathered. In this case recovery turbines were directly geared to the output shaft. This conceptually simple process creates most difficult mechanical problems.

There have been many proposals for recovering power from jacket engine heat. Most of these are a Rankine cycle such as a steam engine which operates from jacket heat. Operating a separate thermal cycle to recover the so called jacket heat is well worth while if this can be done in a reasonable package. It is also concluded from the previous paragraph that turbocompounding is fruitful. Implementation of both turbocompounding and exhaust heat recovery would be ideal. This so called Double Compounding has received some attention. One of the more recent proposals is U.S. Pat. No. 7,062,915. Theoretically, both jacket heat and exhaust heat is recovered. This method has major drawbacks that prevent practical implementation. The Johnson U.S. Pat. No. 3,498,053 as further advanced by Hope, U.S. Pat. Nos. 5,555,730, 5,673,560 and 5,673,560 is one of the better attempts at a practical engine. Air and exhaust are the only working fluids. But still, great complexity remains. The engine requires large number of parts, many of which operate at high temperature. In the latter citation the engine requires three crank shafts many turbine parts, heat exchangers, belts and mechanical gearing of the high RPM turbo shaft to the crank. It is doubtful that the double compounding would recover the power necessary to turn the ancillary equipment.

### BRIEF SUMMARY OF THE INVENTION

This present patent teaches a practical approach to a double compound internal combustion engine. A unique, piston based, two cycle expander combusts the fuel and carries out the first expansion. Exhaust and jacket heat so produced are operated on by two subsequent cycles to provide additional mechanical power. Three thermodynamic cycles operate together. However the components carrying out these three cycles are shared between the cycles making a mechanically simple device. There are no external heat exchangers. The only working fluids are air and exhaust. There are no valves, pumps, cam shafts, gears or belts.

This so disclosed engine depends heavily on electronic motor/generators. These are preferably the emerging switched or variable reluctance type. These motor/generators are capable of high RPM operation needed by turbo equipment. The electronic control provides variable ratio and the ability to use a single device as either a motor or a generator.

This disclosed engine also depends on refractory insulation of the upper cylinder and piston top. This insulation is more than a coating. The insulating refractory actually blocks significant heat flow. The inside refractory layer operates adiabatically by floating at the pressure weighted average combustion temperature. The high temperature layer of refractory reduces unwanted combustion gas heat exchange to the container while increasing the heat delivered to cooling air. Waste heat does not flow through metal parts to be removed. Cooling air is applied internally and hyperbarically. Less air is required but the air that is used is heated to higher temperature.

Two pistons share a common combustion chamber. There are no valves. The head can be one solid piece of refractory. It is essential that the pistons travel parallel to each other and each have their own crank shaft throw. The crank throws are separated by the angle needed to bring both pistons to TDC at the same time. The crank is centered between the two bores. Thus, when the engine is observed from the front end of the crank, one cylinder is offset to the right and the other cylinder is offset to the left. The offset provides essential phase differences in piston movement. It is common on these types of engine to have the piston pair share one crank throw. The second rod is attached to the first rod at a bearing or a flex point. Some times the second piston is attached at the end of a cantilevered beam. When this is the case the pistons arrive at TDC at different times. This can be tolerated in spark ignition engines but the engine will not develop enough compression to operate compression ignited.

The engine breathes through ports at the bottom of the bore. Combustion air is pressurized hence there is no need to use the crankcase to induce charge into the cylinder. The crankcase is quasi-sealed with its own lubricant. No lubricant is added to the fuel. The slower movement of the pistons in the lower part of their stroke works to advantage since the bottom of the stroke is where engine breathing and engine cooling takes place. More time is allowed for breathing to occur.

One of the cylinders contains the intake port and the other cylinder contains the exhaust ports. The higher exhaust port is the blow down port and is uncovered first. Blow down is channeled to the high pressure rotor of a two stage turbine. The lower exhaust port is channeled to the low pressure turbine wheel which is also the second stage for the high pressure wheel. The lower port receives most of the cooling air which is at blower pressure.

On the same shaft with the two stage power turbine is a air pressurizing turbine and a motor/generator. This three part turbo unit is the only accessory to the engine. However both turbocompounding and a hot air engine are running on the exhaust and cooling air. Both cycles are open. No heat exchangers are used.

This invention occurred in Indiana at a company called Indiana North. It is suggested that the engine be referred to as the IN engine and the thermodynamic cycle by which it operates be referred to as the IN cycle.

### BRIEF DESCRIPTION OF THE DRAWINGS

FIGS. 1 and 2 are a block indications drawn to illustrate the various operating cycles of the IN engine. This is not a preferred operation embodiment.

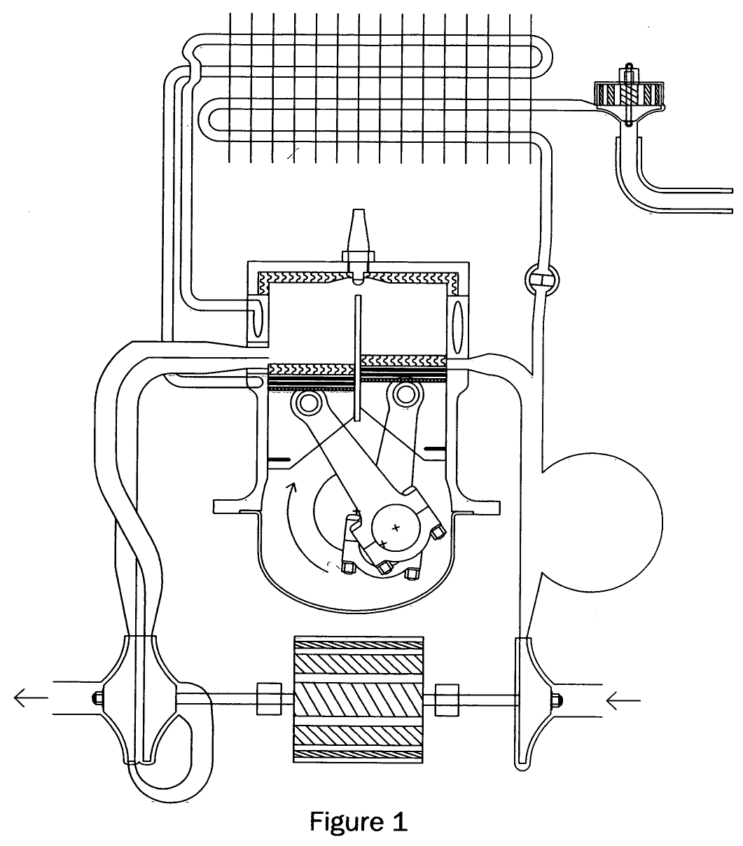

FIG. 2 has identification numbers that go along with the Description of the Invention.

FIG. 3 is the same engine block drawing but is drawn at four different points of crankshaft rotation. The relationship of the pistons to each other and to the ports is shown. Important parts are numbered to correspond with the Description of Operation.

FIG. 4 is a preferred embodiment having three sets of coupled pistons. Notice that the crank is vertical. The flywheel, which is also the rotor of a motor/generator rotates in a horizontal plane. Not shown is a turbocharger which also has its shaft vertically orientated. This orientation allows the inertial masses to rotate in a horizontal plane. In an automotive application the car can turn right or left with out fighting gyroscopic forces. This results in less bearing wear and no resistance to turn.

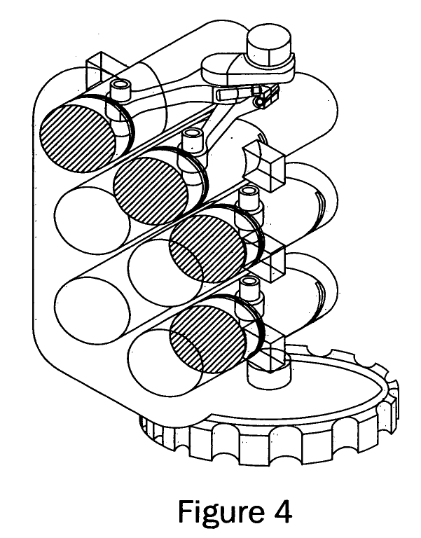

### DETAILED DESCRIPTION OF THE INVENTION

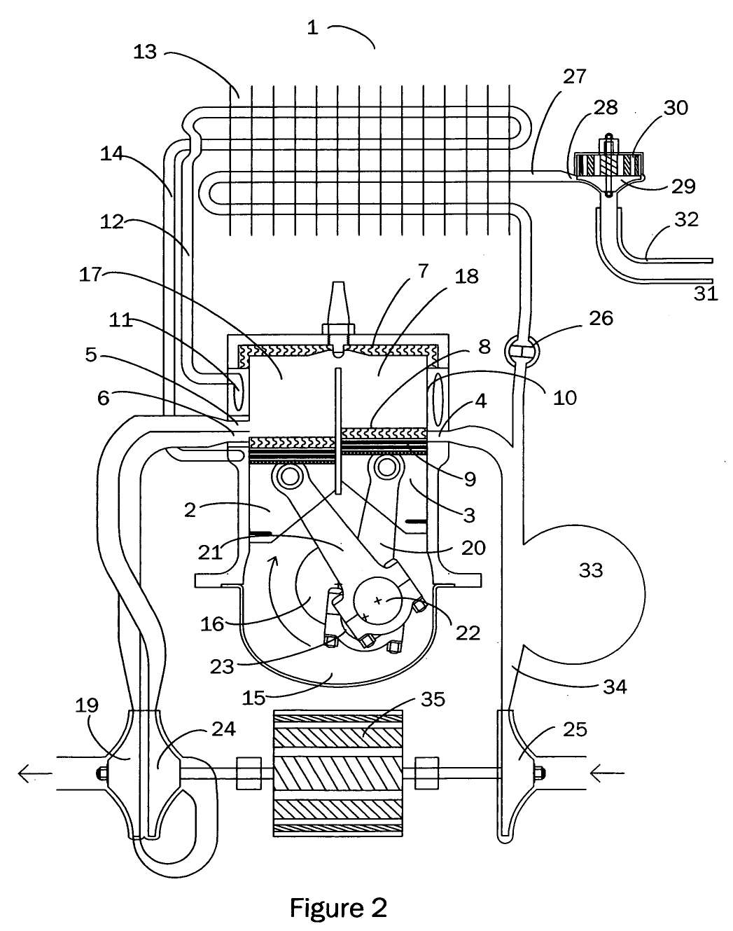

An engine 1 in FIG. 2, comprising of at least one pair of pistons 2 and 3, with intake port 4 and exhaust ports 5 and 6. The head and piston top of said engine is lined with a suitable insulating material 7 and 8 such that the heat flow normally occurring in typical prior art engines does not occur in significant amounts. Piston seal is accomplished by rings 9 that slide on and accomplish a seal on cylinder surface 10. Since conventional rings, cylinder surface and lubricant is used it is necessary to keep the cylinder at a temperature below that of the contained gas. This is accomplished by a heat pipe type mechanism consisting of a chamber 11 encircling the cylinder where ring seal takes place, vapor line 12, convection cooler 13 and liquid line 14. Coolant flow is accomplished by gravity and the system is hermetically sealed.

The pistons are operated by a conventional crankshaft 16 and connecting rods 20, 21 and lubricated by conventional lubricant stored in crankcase 15. What is not conventional is the location of the crankshaft. With the crankshaft rotating clockwise, the intake cylinder 18 is on the right and the exhaust cylinder 17 is on the left. The cylinders are identified by the port they contain. Each rod and associated piston has its own crank shaft throw 22, 23. The crank throws of an associated piston pair are separated by a small angle chosen such that the two pistons arrive at top dead center (TDC) at the same time.

A specialized recovery turbine 19, 24, compressor turbine 25 and generator/motor 35 is associated with said invention. All three components are on the same shaft and turn at the same speed. The recovery turbine is two section consisting of high pressure stage 24 and low pressure stage 19. Motor/generator 35 is of the switched reluctance type with associated electronic controller, not shone, that enables it to be a motor or generator as supervised by the electronic controller unit, also not shone. Turbine speed is determined by the electronic controller and is independent of crankshaft speed. This enables the controller to select the best turbine speed. At start up and low speed operation where the turbine does not provide sufficient power to meet air demand, the electric motor makes up the deficit. At times when excess shaft power is available the motor switches to generate power which is delivered to the battery or external load. The motor also can be used to help spool up the turbine for increased throttle response. Operation of this engine mandates a battery of an appropriate minimum capacity. In a hybrid application the battery would be the main drive battery.

Air turbine 25 provides pressurized air for combustion, hot air engine recovery cycle and in the case of an automobile application, comfort cooling. Combustion air and air for the hot air cycle is admitted through intake port 4. Comfort cooling uses pressurized air flowing through valve 26 and through convection cooler 27. The air is then expanded through orifice 28 into a small turbine 29 doing work. This work is changed to electrical energy by generator 30 with the resulting electrical power deposited in the battery or an external load. Cool air 31 flows to the passenger compartment. At times of high humidity, liquid water will condense in the cool stream. Such water is dropped out of the air stream in an absorbent section 32 of duct 31. Surge chamber 33 at outlet of the pressurizing turbine 25 allows steady air flow through the pressurizing turbine even though engine use is cyclic. The cylinderic shape of the surge chamber 33 with tangential introduction of air at 34 is an attempt to conserve at least some of the kinetic energy in the moving air stream.

As mention in the abstract, the preferred output of this engine is electricity. A switched reluctance motor/generator is flywheel mounted. When engine power is drawn as electrical power, the generator changes the shaft power of the piston expander to the required electrical power. The same switched reluctance device serves as the engine starter. When power output is desired as shaft power, other electrical power sources such as the turbo unit, air conditioning expander and external sources such as regenerative braking feed their power to the flywheel mounted switched reluctance motor/generator to be converted to shaft power. This takes one more conversion step hence results in slightly less efficiency.

A description of one working cycle follows:

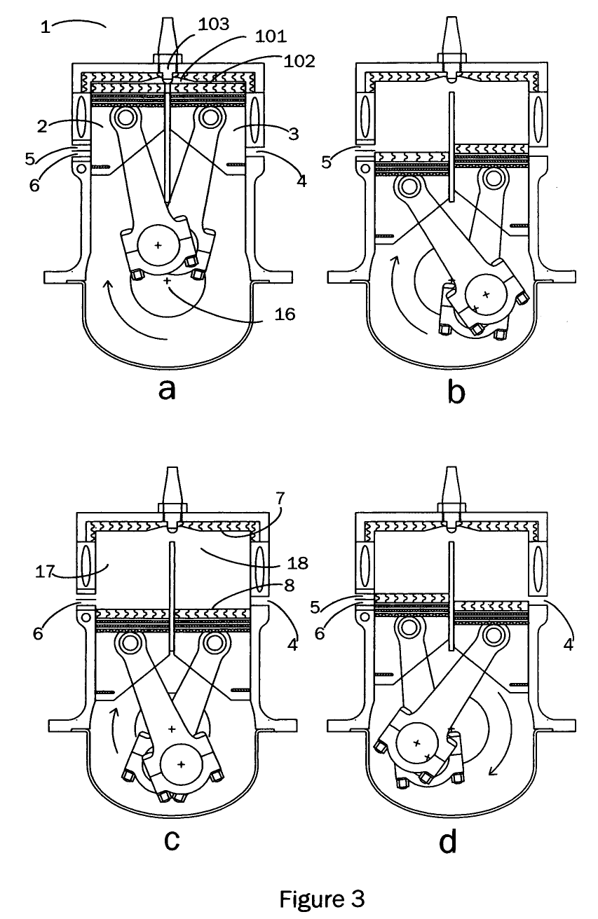

Starting with both pistons at TDC, as illustrated in part a of FIG. 3, the engine 1 has completed the compression stroke and combustion air is compressed in the small common clearance volume 101 and clearance space 102 around the dual pistons Both the intake port 4 and the exhaust ports 5, 6 are closed. Fuel under high pressure is injected at injection point 103. Combustion initiates and continues as the pistons are pressed down the bores in the power stroke.

Because of need to reduce Nitrogen Oxides, fuel injection is spread over approximately 30 crank degrees. Combustion takes place under more or less a constant pressure condition. This is a departure from conventional engines that burn their fuel under a more or less constant volume condition. Constant pressure combustion lowers peak pressure and temperature. Significantly less Nitrogen Oxide is produced but exhaust temperatures are higher and efficiency suffers. But low primary expander efficiency is not a big concern in this case since other cycles follow that will recover the energy.

The pistons 2 and 3 continue down the bore as the charge burns. The first expansion of the hot gasses is accomplished. The pistons do not travel at the same rate. They are together at TDC and Bottom Dead Center (BDC) but those two points are the only points the pistons are together. When the pistons travel down the bore, both connecting rods are on the right side of the crank shaft center 16. The exhaust piston 2 leads the intake piston 3. The exhaust piston 2 uncovers exhaust port 5, FIG. 3b, and cylinder pressure blow down occurs. The high pressure, high temperature exhaust gas is directed to the high pressure section 24 of the recovery turbine.

The piston pair continue down their respective cylinders uncovering intake port 4 and the remaining exhaust port 6, FIG. 3c. Pressurized air enters at intake port 4, travels up the intake cylinder 18 across the head 7 down the exhaust cylinder 17 and out port 6 to the low pressure turbine wheel 19. As the air traverses the hot insulation of the head 7 and the piston tops 8 it picks up heat. The air leaving exhaust port 6 has more energy that the air entering intake port 4 so a net gain of output is achieved if the turbine wheels are sufficiently efficient.

Crank shaft rotation continues and pistons 2 and 3 reach BDC together. On the upstroke the exhaust piston leads the intake piston and as illustrated in FIG. 3d the exhaust ports 5 and 6 close before the intake port 4. This phase difference is unique to the crank offset geometry and crucial to engine operation. The closing of the exhaust port before the intake port enables the blower to bring both cylinders up to full blower pressure prior the start of compression stroke.

All crank operated slider piston engines exhibit higher piston velocity in the upper half of the piston stroke with corresponding lower piston velocity in the lower half stroke. In conventional engines with a rod ratio (rod length/stroke) of 1.6 and with the crank center on the bore center line, piston velocity peak in the upper half is four percent higher than in the lower half. The piston spends 45% of its time in the upper half of the bore and 55% of its time in the lower half. As the crank is offset from the bore center, velocity difference becomes significantly greater, around 30%. Piston offset with the corresponding velocity difference works to advantage in this disclosed engine. The compression and expansion stroke is carried out rapidly. The piston then moves slower when the ports are open and ventilation occurs.

What is claimed is:

1. A piston based internal combustion engine comprising in combination paired cylinders such that
a parallel relationship exists between center lines of said cylinder pair and with
a single combustion chamber shared at the top of said cylinder pair when the cylinder axis is vertical and
a piston slideably deployed in each cylinder of said cylinder pair and
an insulating layer covering the combustion inside wall of the head of said combustion chamber and
an insulating layer covering the combustion contacting area of each piston and
a crankshaft deployed at the bottom of said vertically oriented cylinder pair, said crankshaft turning about an axis extending generally perpendicularly to a plane passing through the axis of at least one cylinder the piston of which is drivingly connected thereto, wherein the cylinder axis, if extended, would not intersect the crankshaft axis and said crankshaft and
having two throws for each cylinder pair with each piston rod combination connected to its own crankshaft throw.

2. The system as in claim 1 wherein breathing ports are cut at the bottom of the cylinder wall.

3. The system as in claim 1 wherein a suitable air pressurizing device is coupled to one breathing port and
a turboexpantion device is connected to a port or ports in the other cylinder of said cylinder pair
a mechanical means for rotationally coupling said air pressurizing turbine and said turboexspantion device.

4. The system as in claim 3 where said rotationally coupled device also rotatably operates a motor/generator.

5. A method of combining multiple heat engine cycles within one basic engine
providing an air pressurizer serving combustion air and a hot air cycle requirements
arranging a turbine wheel extracting energy from the exhaust stream and from the hot air engine effluent
positioning said combustion chamber such that it becomes a container for fuel combustion in addition to
becoming a heat exchange surface for transfer of jacket heat to cooling air and
freeing said combustion chamber from encumbrances and
insulating said combustion chamber wall such that the surface of said insulation operates at high temperature and by such provides good heat flow and high engine efficiency.

6. A method as in claim 5
providing a single shaft rotationally
supporting an energy recovery turbine, motor/generator and air pressurizer.

7. A method of
generating rotational phase differences between said paired pistons described in claim 1
enabling said exhaust port of said cylinder pair to open prior to the opening of all other ports and also close prior to the closing of all other ports
providing substantially higher piston velocity when the piston is in the upper part of it's stroke and substantantially lower piston velocity when the piston is in the lower part of its stroke as compared to a normal slider piston where the crank shaft is on the center of the cylinder bore.
